(19) United States
(12) Patent Application Publication
(10) Pub. No.: US 2007/0232150 A1
(43) Pub. Date: Oct. 4, 2007

(54) Audio jack connector

(75) Inventor: Yun-Chien Lee, Tu-Cheng City (TW)

Correspondence Address: BIRCH STEWART KOLASCH & BIRCH, PO BOX 747, FALLS CHURCH, VA, 22040-0747, US

(73) Assignee: Cheng Uei Precision Industry Co., Ltd.

(21) Appl. No.: 11/396,629

(22) Filed: Apr. 4, 2006

(51) Int. Cl. H01R 24/04

(52) U.S. Cl. 439/668

(57) ABSTRACT

An audio jack connector includes a housing and a set of contacts. The housing has a body, a mating portion extending from one end of the body and an insertion hole defined in the mating portion and extending inwardly through the body along an axis direction. The set of contacts includes signal contacts, a set of switching contacts disposed in the housing and an exposed contact disposed at the outside of the housing. The switching contacts have a fixed contact and a movable contact. The mating portion of the housing has a cavity defined at outer surface thereof for receiving a contacting portion of the exposed contact. The contacting portion has a propping block protruding outwardly beyond the outer surface of the mating portion. Therefore, the audio jack connector and the mating plug connector mate with each other firmly.

### BACKGROUND OF THE INVENTION

1. Field of the Invention

The present invention relates to a jack connector, and more particularly to an audio jack connector.

2. The Related Art

U.S. Pat. No. 6,575,793 discloses an audio jack connector for mating with a mating plug connector. The audio jack connector includes a housing and a set of contacts received in the housing. The housing has a body, a mating portion extending from one end of the body, and an insertion hole defined in the mating portion and extending inwardly through the mating portion and the mating body along an axis direction. The set of contacts includes signal contacts and at least a set of switching contacts received in the housing. When the audio jack connector mates with a mating plug connector, the mating portion of the audio jack connector is received in an outer metal shell of the mating plug connector.

However, there is no locking structure arranged in the mating portion of the audio jack connector and the outer metal shell of the mating plug connector. Therefore, the engagement between the audio jack connector and the mating plug connector is not enough firm.

### SUMMARY OF THE INVENTION

An object of the present invention is to provide an audio jack connector including a housing and a set of contacts. The housing has a body, a mating portion extending from one end of the body and an insertion hole defined in the mating portion. The insertion hole extends inwardly through the body along an axis direction. The set of contacts includes signal contacts, a set of switching contacts disposed in the housing and an exposed contact disposed at the outside of the housing. The switching contacts have a fixed contact and a movable contact. The mating portion of the housing has a cavity defined at outer surface for receiving a contacting portion of the exposed contact. The contacting portion has a propping block protruding outwardly beyond the outer surface of the mating portion. Therefore, the audio jack connector and the mating plug connector mate with each other more firmly. Simultaneously, a circuit function, such as a protecting circuit, is provided between the audio jack connector and the mating plug connector.

### BRIEF DESCRIPTION OF THE DRAWINGS

The present invention will be apparent to those skilled in the art by reading the following description of a preferred embodiment thereof, with reference to the attached drawings, in which:

FIG. 1 is a perspective view of an audio jack connector in accordance with the present invention;

FIG. 2 is a perspective view of the audio jack connector viewing from bottom side;

FIG. 3 is an exploded view of the audio jack connector of FIG. 1;

FIG. 4 is an exploded view of the audio jack connector viewing from bottom side.

### DETAILED DESCRIPTION OF THE PREFERRED EMBODIMENT

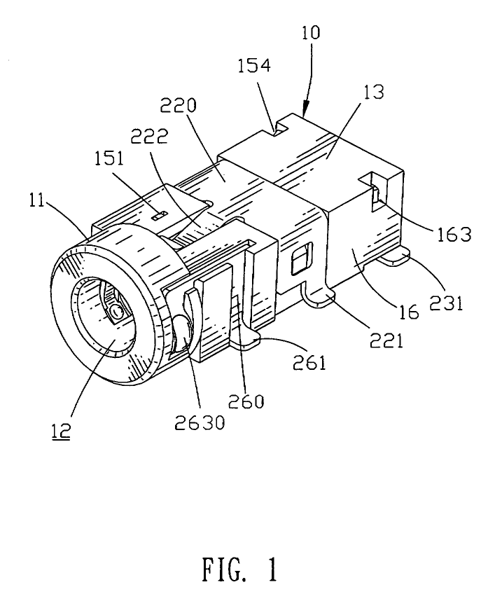

With reference to FIG. 1, an audio jack connector 100 adapted for mating with a mating plug connector (not shown) includes a housing 1 and a set of contacts received in the housing 1. The housing 1 has a body 10, a mating portion 11 extending from one end of the body 10, and an insertion hole 12 defined in the mating portion 11 and extending inwardly through the body 10 along an axis direction.

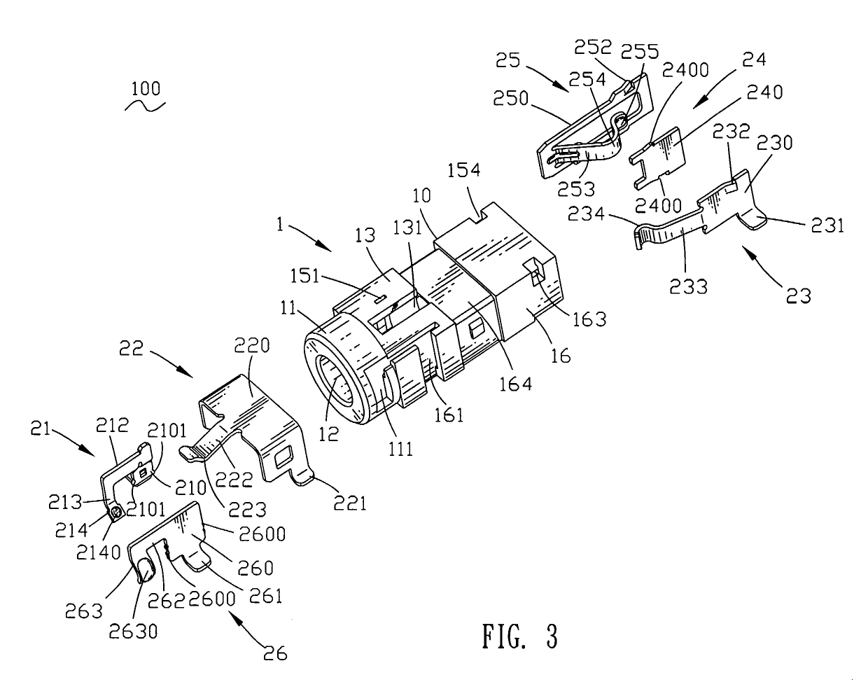

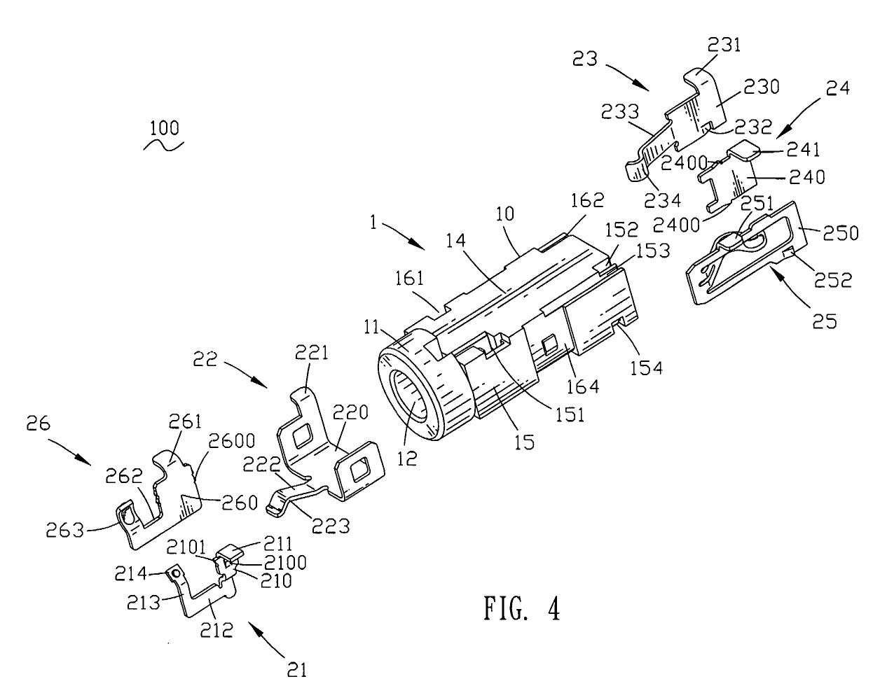

Referring to FIG. 3 and FIG. 4, the body 10 has a top wall 13, a bottom wall 14, a first sidewall 15 and a second sidewall 16. The first sidewall 15 has a first contact passageway 151 defined at the front portion thereof, an inside fourth contact passageway 152 and an outside fifth contact passageway 153 defined at the rear portion thereof and a first lock opening 154 communicating with the five contact passageway 153. The first lock opening 154 is defined at the top portion of the rear portion of the first sidewall 15. The second sidewall 16 has a sixth contact passageway 161 defined at the outside of the front portion thereof, a third contact passageway 162 defined at the rear portion thereof and a second lock opening 163 communicating with the third contact passageway 162. The second lock opening 163 is defined at the top portion of the rear portion of the second sidewall 16. The top wall 13 has an opening 131 penetrating through the top wall 13 from top to bottom and communicating with the insertion hole 12. A second contact passageway 164 is formed on the first sidewall 15, the second sidewall 16 and the top wall 13. The second contact passageway 164 is a U-shaped contact passageway.

Referring to FIG. 3, the mating portion 11 is of a hollow cylinder configuration. The mating portion 11 has a cavity 111 defined at one side to communicate with the sixth contact passageway 161 of the second sidewall 16.

Referring to FIG. 3 and FIG. 4 again, the set of contacts includes a set of signal contacts named a first contact 21, a second contact 22 and a third contact 23, and a set of switching contacts composed of a fixed contact named a fourth contact 24 and a movable contact named a fifth contact 25. The set of contacts further includes an exposed contact named a sixth contact 26.

The first contact 21 has a first fixed portion 210, a solder portion 211 bending and extending outwardly from the bottom portion of the first fixed portion 210 and a first connecting portion 212 extending forward from the top portion of the first fixed portion 210. The first contact 21 further has a first elastic arm 213 extending downwardly from the end of the first connecting portion 212, and a first contacting portion 214 extending from the end of the first elastic arm 213. The fixed portion 210 has a wedge 2100 protruding from outer surface thereof and a pair of first protruding thorns 2101 respectively disposed at the top portion of two sides thereof. The first contacting portion 214 has a protruding block 2140 of a half sphere configuration protruding from top surface thereof.

The second contact 22 has an approximate U-shaped second fixed portion 220, a second solder portion 221 bending and extending outwardly from the bottom portion of one side of the second fixed portion 220, a second elastic arm 222 extending forward from the second fixed portion 220 and a second contacting portion 223 extending from the end of the second elastic arm 222.

The third contact 23 has a third fixed portion 230, a third solder portion 231 bending and extending downwardly from the bottom portion of the third fixed portion 230 and a first broken portion 232 disposed at the top portion of the third fixed portion 230. The third contact 23 further has a third elastic arm 233 extending forward from the third fixed portion 230 and a third contacting portion 234 extending from the end of the third elastic arm 233.

The fourth contact 24 has a fourth fixed portion 240, a fourth solder portion 241 bending and extending outwardly from the bottom portion of the fourth fixed portion 240. A pair of second protruding thorns 2400 are respectively disposed at upper and lower sides of the fourth fixed portion 240.

The fifth contact 25 has a fifth fixed portion 250 of an approximate rectangular loop configuration, a fifth solder portion 251 bending and extending outwardly from the bottom portion of the fifth fixed portion 250 and a second broken portion 252 disposed at the top portion of the fifth fixed portion 250. The fifth contact 25 further has a fifth elastic arm 253 extending backwardly from the front portion of the fifth fixed portion 250, a fifth contacting portion 254 extending from the end of the fifth elastic arm 253 and a switching portion 255 extending from the end of the fifth contacting portion 254. The switching portion 255 locates between the fifth fixed portion 250 and the fifth contacting portion 254.

The sixth contact 26 has a sixth fixed portion 260, a sixth solder portion 261 bending and extending outwardly from the bottom portion of the sixth fixed portion 260, a second connecting portion 262 extending forward from the top portion of the sixth fixed portion 260 and an arc sixth contacting portion 263 extending downwardly from the end of the second connecting portion 262. The sixth fixed portion 260 has two pairs of third protruding thorns 2600 respectively disposed at front and back sides thereof. The sixth contacting portion 263 has a propping block 2630 of a spoon configuration protruding from outer surface thereof.

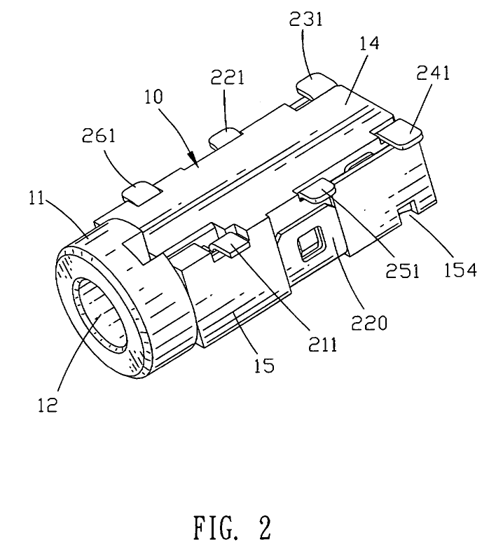

Please referring to FIG. 1 and FIG. 2, in assembly, the fixed portions 210, 220, 230, 240, 250, 260 of the first contact 21, the second contact 22, the third contact 23, the fourth contact 24, the fifth contact 25 and the sixth contact 26 are respectively fixed in the first contact passageway 151, the second contact passageway 164, the third contact passageway 162, the fourth contact passageway 152, the fifth contact passageway 153 and the sixth contact passageway 161. The wedge 2100 and the first protruding thorn 2101 of the first fixed portion 210, the second protruding thorn 2400 of the fourth fixed portion 240 and the third protruding thorn 2600 of the sixth fixed portion 260 are jammed in the housing 1. The first broken portion 232 of the third contact 23 and the second broken portion 252 of the fifth contact 25 are respectively locked in the second lock opening 163 and the first lock opening 154. The solder portions 211, 221, 231, 241, 251, 261 extend beyond the bottom wall 14 of the housing 1 for soldering on a circuit board (not shown). The protruding block 2140 of the first contacting portion 214 extends into the insertion hole 12, the second contacting portion 223 extends into the insertion hole 12 from the opening 131 of the top wall 13, the third contacting portion 234 and the fifth contacting portion 254 extend inwardly into the insertion hole 12 and the switching portion 255 of the fifth contact 25 props on outer surface of the fourth fixed portion 240 of the fourth contact 24. The sixth contact 26 is exposed at the outside of the housing 1. The sixth contacting portion 263 of the sixth contact 26 is received in the cavity 111 of the mating portion 11. The propping block 2630 protrudes outwardly beyond outer surface of the mating portion 11.

When the audio jack connector 100 and the mating plug connector mate with each other, a mating contact of the mating plug connector is inserted into the insertion hole 12. The first contacting portion 214, the second contacting portion 223, the third contacting portion 234 and the fifth contacting portion 254 respectively contact with the mating contact. Meanwhile, the mating contact pushes the fifth contacting portion 254 outwardly to bring the switching portion 255 to move outwardly, thus the switching portion 255 is removed away from the fourth fixed portion 240 of the fourth contact 24. When the mating plug connector is removed away from the audio jack connector 100, the switching portion 255 contacts with the fourth fixed portion 240 again by an elastic force.

In the process of insertion, the mating portion 11 is received in a metal shell (not shown) surrounding the mating plug connector. The propping block 2630 of the sixth contact 26 props on inner surface of the metal shell. Therefore, the audio jack connector 100 and the mating plug connector mate with each other firmly. Simultaneously, a circuit function, such as a protecting circuit, is provided between the audio jack connector and the mating plug connector.

1. An audio jack connector comprising:
a housing having a body, a mating portion extending from one end of the body and an insertion hole defined in the mating portion and extending inwardly through the body along an axis direction, the body of the housing has a top wall, a bottom wall, a first sidewall and a second sidewall; and
a set of contacts comprising signal contacts and a set of switching contacts disposed in the housing, the switching contacts having a fixed contact and a movable contact, the signal contacts including at least a first contact and a second contact, the second contact of the signal contacts extending alone the first sidewall across the top wall and along the second sidewall of the body in a U-shaped configuration;
wherein the set of contacts further comprises an exposed contact disposed at the outside of the housing, the exposed contact has a contacting portion, the mating portion of the housing has a cavity defined at outer surface thereof for receiving the contacting portion of the exposed contact, the contacting portion has a propping block protruding outwardly beyond the outer surface of the mating portion.

2. The audio jack connector as claimed in claim 1, wherein the propping block is of a spoon configuration.

3. The audio jack connector as claimed in claim 1, wherein the exposed contact has a fixed portion, a solder portion bending and extending outwardly from the bottom portion of the fixed portion, a connecting portion extending forward from the top portion of the fixed portion, and a contacting portion extending downwardly from the end of the connecting portion.

4. The audio jack connector as claimed in claim 3, wherein the second sidewall has a contact passageway defined at the outside of the front thereof for receiving and fixing the fixed portion of the exposed contact.

5. The audio jack connector as claimed in claim 4, wherein the mating portion is of a hollow cylinder configuration and has a cavity defined at one side to communicate with ha sixth contact passageway of the second sidewall.

6. The audio jack connector as claimed in claim 1, wherein the movable contact has an elastic arm, a movable contacting portion extending from the end of the elastic arm and a switching portion extending from the end of the movable contacting portion, the switching portion is removed away from the fixed contact when the mating plug connector is inserted.

7. The audio jack connector as claimed in claim 1, wherein the signal contacts include a third contact, the first contact being adjacent the insertion hole, the second contact being at a mid-portion of the body and the third contact being at an end of the body away from the insertion hole.

8. The audio jack connector as claimed in claim 7, wherein an opening is provided in the top wall of the body through which an elastic arm of the second contact extends.

9. The audio jack connector as claimed in claim 8, wherein the set of switching contacts includes a fourth contact and a fifth contact, both the fourth and fifth contact being at the end of the body away from the insertion hole on a side of the body opposite to the third contact.

10. The audio jack connector as claimed in claim 9, wherein exposed contact is at an end of the body adjacent the insertion hole and is located primarily on an exterior of the body while the first contact of the signal contacts is located primarily in an interior of the body but is exposed via the insertion hole.
